(19) United States
(12) Patent Application Publication
(10) Pub. No.: US 2019/0183110 A1
(43) Pub. Date: Jun. 20, 2019

(54) Methods For Dispensing Methyl Antrhanilate

(71) Applicant: Bird-B-Gone, Inc., Mission Viejo, CA (US)

(72) Inventor: Bruce Donoho, Laguna Beach, CA (US)

(21) Appl. No.: 15/847,324

(22) Filed: Dec. 19, 2017

(51) Int. Cl. A01M 29/12; A01M 29/14; A01M 29/18; A01N 25/02; A01N 25/34; A01N 37/44

(52) U.S. Cl. CPC A01M 29/12; A01M 29/14; A01M 29/18; A01N 2300/00; A01N 25/34; A01N 37/44; A01M 2200/00; A01N 25/02

(57) ABSTRACT

A method of deterring avian pests from a space includes adding an amount of methyl anthranilate to an evaporator disposed in a space. The evaporator can be passively or actively operated to increase or decrease the off-gassing of methyl anthranilate.

### FIELD OF THE INVENTION

The field of the invention is avian pest deterrence.

### BACKGROUND

The following description includes information that may be useful in understanding the present invention. It is not an admission that any of the information provided herein is prior art or relevant to the presently claimed invention, or that any publication specifically or implicitly referenced is prior art.

Avian pests perch in many places that can be problematic for humans, including for example, rooftops, ledges, and other areas on buildings and homes. Avian pests, such as birds, are associated with significant problems for humans including health hazards from exposure to bird droppings, unsightly messes from bird droppings, unwanted noise, property damage from roosting behaviors, and an undesirable physical presence of avian pests in human-occupied areas. Methyl anthranilate (MA) has been shown to repel avian pests by causing irritation in the respiratory systems and other orifices of birds. The production and use of MA as an odorizer and/or a deodorizer is known in the art.

U.S. Pat. No. 5,200,330 to Page teaches a method of preparing MA, a common odor masking substance, as it has a pleasant grape taste that is often used in both foods and perfumes. U.S. Pat. No. 7,434,586 to Higashi teaches a formulation that uses MA to deodorize tobacco smells, US2003/0044368 to Tsuchikura teaches methods of using MA to deodorize body odor, and US20080009560 to McKay teaches using MA to mask other atmospheric odors. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

It is also known that MA has the ability to deter birds in its aerosolized form. US07334745 to Crawford and US20040035879 to Vergote teach methods of atomizing aqueous MA solutions to repel birds by releasing gases stored at high pressure. Since MA has an attractive, grape smell, it has been considered for in repelling birds from patios, rooftops, spacious storefronts, and other areas where people frequent. However, prior applications of MA in avian pest deterrence use aerosolized MA to effectively coat various surfaces with MA in order to impart an undesirable taste and irritating effect on the avian pests, they do not disperse MA, in a substantially gaseous form, into the ambient air in order to deter birds from occupying particular areas.

Dispersing MA in a substantially gaseous form improves dispersal of MA over the prior art by causes the released MA to stay airborne longer than if it had been released as an aerosol. Also, without being limited to any particular theory or causal relationship, it is thought that by increasing the ability of MA to travel further into a bird's respiratory tract, gaseous MA can increase irritation in the respiratory tracts of avian pests over aerosolized MA, thereby enhancing its deterrent effect.

In addition to improving the efficacy of MA as an avian pest deterrent, gaseous MA avoids the downsides of distributing aerosolized liquids into a space. Aerosolized liquids, mists, and sprays produce tiny liquid droplets that are approximately 10 microns or more in size. Due to their larger size, aerosolized liquids tend to fall onto surfaces, thereby coating the surfaces with the aerosolized liquid. This can be decidedly disadvantageous. For example, deposits of an aerosol can lead to staining or damage of surfaces upon which it lands. In another example, aerosolized liquids dispersed in areas with a high density of people can land on people, and thereby create a damp and unpleasant environment.

As used herein, the terms “gas” and “gases” means an airlike fluid substance comprising free atoms and/or molecules. As used herein, ions are considered to be atoms and/or molecules. Also as used herein, the term “substantially gaseous” means a substance that is at least 90 weight-percent (wt %) of gas, and no more than 10% particulate.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for a method of dispersing methyl anthranilate is a substantially gaseous form to deter avian pests from occupying particular areas.

### SUMMARY OF THE INVENTION

The inventive subject matter provides methods in which methyl anthranilate (“MA”) is dispersed in a substantially gaseous form to deter avian pests from occupying an area.

Methyl anthranilate (C₈H₉NO₂) is an ester of anthranilic acid, and can be used to deter birds from an area by distributing gaseous MA into the area. The gaseous MA is thought to irritate the mouth and lungs of birds that inhale the MA. Preferred MA solutions range from 100% MA to 25 wt % MA. Some contemplated MA solutions have less than 25 wt % MA, less than 20 wt % MA, or even less than 10 wt % of the solution. Preferred solutions of methyl anthranilate are effective to deter birds from an area when at least 5 ml, at least 10 ml, or at least 20 ml of the solution is distributed in gaseous form into an area no greater than 100 m², over a time frame of no more than 1 hour.

MA is preferably mixed in a liquid solution and placed in a device adapted to disperse the liquid solution into the air, in a gaseous form. Gaseous MA can be distributed into an area according to a schedule (e.g., a release of gaseous MA every 5, 10, or 20 minutes), passively released into the air (e.g., releasing a steady supply of evaporated MA into the space using an evaporator), and/or actively released (e.g., a timed release of MA or a constant release of MA using an ultrasonic evaporator).

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts an evaporator comprising a fan and a cartridge containing methyl anthranilate.

FIG. 2 depicts an ultrasonic evaporator comprising a reservoir adapted to contain and receive methyl anthranilate.

FIG. 3 depicts a heat-based evaporator comprising a heat source and a cartridge containing methyl anthranilate.

FIG. 4 depicts a passive evaporator comprising a cartridge containing methyl anthranilate, wherein the methyl anthranilate is evaporates into the air without using external heat, external agitation, and external pressure.

FIG. 5 depicts a passive evaporator comprising a material infused with a solution comprising methyl anthranilate that is exposed to air.

FIG. 6 depicts a substantially enclosed warehouse with multiple evaporators containing methyl anthranilate placed in each corner of the enclosed warehouse and the entrance.

FIG. 7 depicts a porch with multiple evaporators containing methyl anthranilate placed in two corners of the semi-enclosed space.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

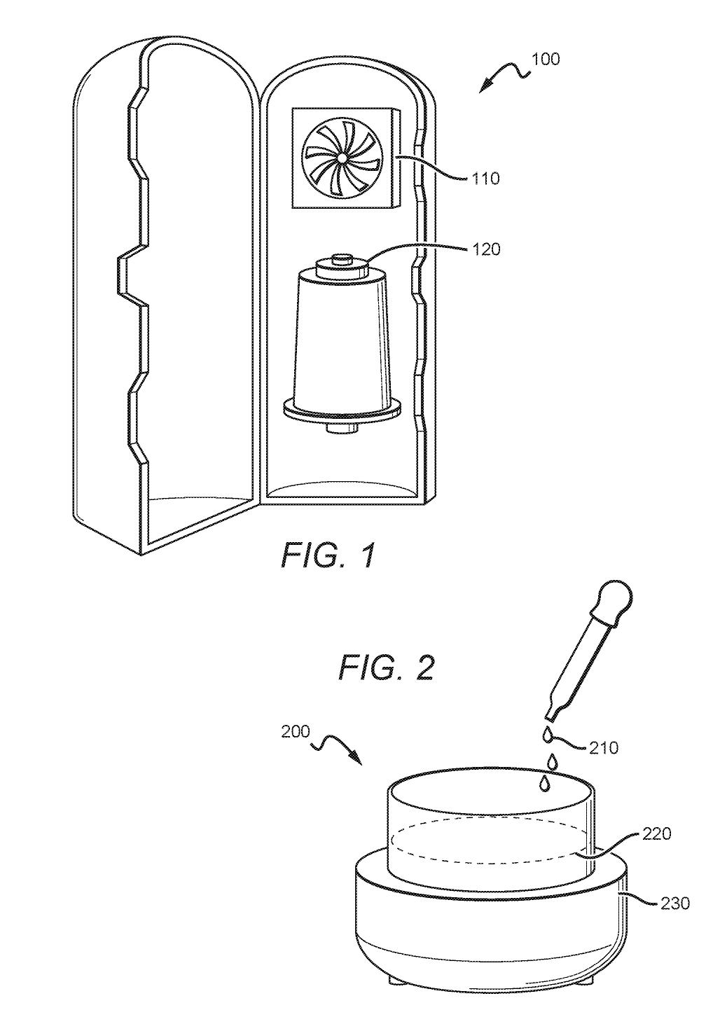

FIG. 1 depicts one embodiment of evaporator 100 comprising fan 110 and cartridge 120 containing methyl anthranilate (“MA”).

Cartridge 120 is configured to expose the MA in the lumen of cartridge 120 to air. Cartridge 120 can have an opening at one end of the lumen. Cartridge 120 can also comprise a wick with one portion of the wick contacting the MA in the lumen of cartridge 120 and another portion of the wick contacting the air outside of the lumen, such that liquid MA is exposed to the air by capillary action.

Fan 110 is coupled to cartridge 120 and is configured to accelerate the offgassing of MA by increasing airflow around cartridge 120. In a preferred embodiment, fan 110 is a cross-flow fan comprising an impeller with forward curved blades that moves air transversely across the impeller. It is contemplated that fan 110 can be any means of increasing air circulation, such as a centrifugal fan, an axial-flow fan, a bellow, a convective fan, and an electrostatic fan. Evaporator 100 can also comprise a timer that selectively activates fan 110 based on a preset schedule. For example, a user can set evaporator 100 to activate fan 110 between the hours of 7:00 AM and 6:00 PM when customers dine on the patio and deactivate from 6:00 PM to 5:00 AM when the restaurant is typically closed. In other embodiments, evaporator 100 can also be connected to a variety of sensors, such as light sensors, movement sensors, and sound sensors. Evaporator 100 can employ one or more of these sensors to selectively activate fan 110 if certain conditions are met.

In alternative embodiments, evaporator 100 does not include fan 110. For example, evaporator 100 may allow MA to off-gas passively and/or enhance the off-gassing of MA without substantially increasing airflow around the cartridge, such as by increasing surface area of MA contacting air. Off-gassing is the release of chemicals in gaseous form from a material.

FIG. 2 depicts ultrasonic evaporator 200 comprising reservoir 220 adapted to receive and contain methyl anthranilate 210.

In the depicted embodiment, ultrasonic evaporator 200 comprises a diaphragm that can vibrate at an ultrasonic frequency using a piezoelectric transducer to create a high frequency mechanical oscillation in a film of a liquid. The high frequency mechanical oscillation causes the liquid to eject an extremely fine mist of droplets which is quickly evaporated into the air flow. It is contemplated that the droplets are about one micron in diameter.

Ultrasonic evaporator 200 can also comprise a timer that selectively activates the piezoelectric transducer based on a preset schedule. For example, a user can set ultrasonic evaporator 200 to activate between the hours of 5:00 AM and 6:00 PM when birds are most active and to deactivate from 6:00 PM to 5:00 AM when birds typically roost. In other embodiments, ultrasonic evaporator 200 can also be connected to a variety of sensors, such as light sensors, movement sensors, and sound sensors. Ultrasonic evaporator 200 can employ one or more of these sensors to selectively activate the piezoelectric transducer if certain conditions are met.

MA 210 is liquid methyl anthranilate. MA 210 can comprise a mixture of MA and other liquids, such as water or alcohols, to be ejected as an extremely fine mist of droplets.

Reservoir 220 can be any physical structure adapted to receive and contain MA 210. In a preferred embodiment, reservoir 220 is a cup shaped structure coupled to ultrasonic evaporator 200. Reservoir 220 can also be a closeable container, such as a cup with a lid. In preferred embodiments, MA 210 is ejected as a fine mist directly from reservoir 220. However, reservoir 220 can be as a temporary holding structure that holds MA prior to ultrasonic evaporation at a different location. For example, reservoir 220 may be coupled to ultrasonic evaporator 200 by a conduit through which MA and other liquids can flow for high frequency mechanical oscillation at a separate site.

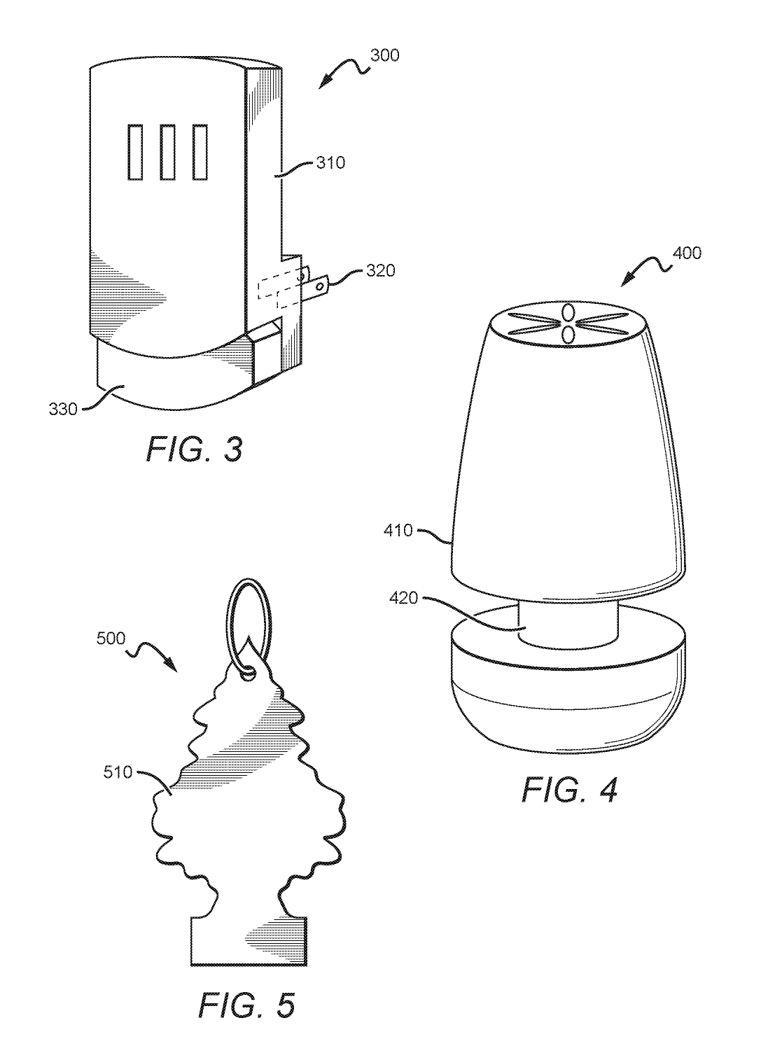

FIG. 3 depicts heat-based evaporator 300 comprising a heat source 310, a power conduit 320, and cartridge 330 containing MA.

In the depicted embodiment, heat source 310 can be an electrical element configured to convert electric current to heat. For example, heat source 310 can comprise an electrical resistor that works on the principle of Joule heating to convert electrical energy into heat energy. In a preferred embodiment, the heat intensity of heat source 310 is adjustable to control the amount of MA off-gassing. It is contemplated that heat source 310 can use any mechanism that can introduce heat into heat-based evaporator 300, such as mechanisms that use combustion, chemical, convection, radiation, and/or induction.

Power conduit 320 is preferably an outlet plug that draws a current from a line power source. Alternatively, heat-based evaporator 310 may not comprise power conduit 320. For example, heat-based evaporator 300 can use a combustion based heat source, such as a candle to provide heat to heat-based evaporator 300. In another example, heat-based evaporator 300 can use an activated exothermic chemical reaction to introduce heat to the system.

Heat-based evaporator 300 can also comprise a timer that selectively activates the heat source 310 based on a preset schedule. For example, a user can set heat-based evaporator 300 to activate between the hours of 5:00 AM and 6:00 PM when birds are most active and to deactivate from 6:00 PM to 5:00 AM when birds typically roost. In other embodiments, heat-based evaporator 300 can also be connected to a variety of sensors, such as light sensors, movement sensors, and sound sensors. Heat-based evaporator 300 can employ one or more of these sensors to selectively heat source 310 if certain conditions are met.

Cartridge 330 contains MA. Cartridge 330 could have an opening at one end of the lumen. Cartridge 330 could also comprise a wick with one portion of the wick contacting the MA in the lumen of cartridge 330 and another portion of the wick contacting the air outside of the lumen, such that liquid MA is exposed to the air by capillary action.

FIG. 4 depicts passive evaporator 400 comprising a cartridge 420 containing MA that evaporates into the air without using external heat, external agitation, and/or external pressure.

Passive evaporator 400 can preferably be switched between an open configuration and a closed configuration. In some embodiments, passive evaporator 400 could use a screw type mechanism that switches between open and closed configuration when passive evaporator 400 is twisted in a particular direction. Passive evaporator 400 could also use a friction based mechanism that allows a user to switch from a closed to an open configuration by exerting force on passive evaporator 400. For example, a user may pull apart two slidably coupled ends of passive evaporator 400 to expose the internal MA to air.

Preferably, cartridge 420 comprises an absorbent material infused with MA. For example, cartridge 420 can be an MA impregnated gel, wax, paper, sponge, and/or wood that releases MA by off-gassing. Cartridge 420 can store MA in a lumen with an opening at one end of the lumen that allows for off-gassing. Cartridge 420 could also comprise a wick with one portion of the wick contacting the MA in the lumen of cartridge 420 and another portion of the wick contacting the air outside of the lumen, such that liquid MA is exposed to the air by capillary action.

FIG. 5 depicts passive evaporator 500 comprising an infusible material 510 that is substantially contains a solution comprising MA and exposes the surface area of infusible material 510 to air.

It is contemplated that infusible material 510 would preferably comprise materials such as papers and gels. For example, infusible material 510 could be a highly absorbent cardboard soaked in an MA solution. In another example, infusible material 510 could be an agarose-based gel impregnated with an MA solution.

It is also preferred that infusible material 510 is configured to maximize the surface area of passive evaporator 500, which consequently increases off-gassing of the MA solution into the air. In some embodiments, the physical configuration of passive evaporator 500 and the type of infusible material used can be tailored to control the off-gassing of MA to an amount appropriate for the space. For example, a passive evaporator for a small space, such as a shed, can be smaller and expose less surface area to air than a passive evaporator for a larger space, such as a garage.

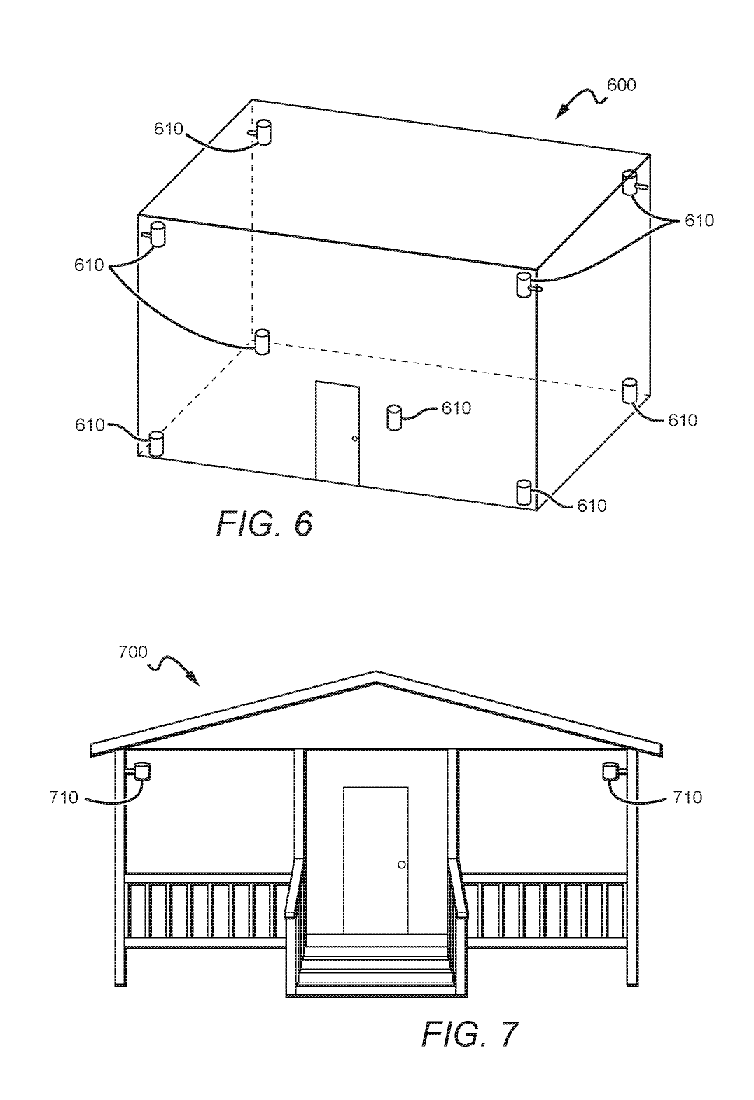

FIG. 6 depicts a substantially enclosed warehouse 600 with evaporators 610 containing MA placed in each corner of the warehouse 600 and the entrance of warehouse 600.

It is contemplated that evaporators 610 used in the depicted embodiment are preferably active evaporators with more effective off-gassing capabilities, such as fan-based, ultrasonic, and/or heat-based evaporators. For example, warehouse 600 can be fitted with heat-based evaporators that are plugged into electrical outlets and convert electrical energy to heat energy using a resistor. It is contemplated that any combination of active evaporators and passive evaporators can be used based on the particular requirements of a substantially enclosed space.

FIG. 7 depicts a semi-enclosed space 700 with evaporators 710 containing MA placed in two corners of the semi-enclosed space.

It is contemplated that evaporators 710 used in semi-enclosed or open environments can be passive or active evaporators based on whether or not a power source is available. For example, semi-enclosed space 700 can be fitted with passive evaporators that are placed in the corners of the semi-enclosed space where power sources are not readily available. Porch 700 can also be fitted with active evaporators, such as electrically power evaporators, where there is access to a power source, such as electrical outlet.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of deterring avian pests from entering a space, comprising:
placing an evaporator in the space, the evaporator configured to release a substance into the atmosphere;
adding an amount of methyl anthranilate to the evaporator; and
operating the evaporator to release the methyl anthranilate into the atmosphere in a substantially gaseous form.

2. The method of claim 1, wherein at least 90 weight percent (wt %) of the methyl anthranilate leaves the device as a gas.

3. The method of claim 1, wherein the evaporator is selected from the group consisting of: a heat-based evaporator, and an ultrasonic evaporator.

4. The method of claim 3, wherein the active evaporator comprises a fan and a cartridge, wherein the cartridge contains the methyl anthranilate in a liquid state.

5. The method of claim 1, wherein evaporator is a passive evaporator, which dispenses the methyl anthranilate into the atmosphere gas without using external heat, external agitation, or external pressure.

6. The method of claim 5, wherein operating the passive evaporator further comprises performing a mechanical operation to reveal an opening, wherein the opening exposes the methyl anthranilate to air.

7. The method of claim 1, wherein the space is an open space.

8. The method of claim 1, wherein the step of adding the amount of the methyl anthranilate to the evaporator comprises adding an amount of liquid methyl anthranilate to a solution previously disposed in the evaporator.

9. The method of claim 1, wherein adding the amount of the methyl anthranilate to the evaporator further comprises coupling a cartridge containing the methyl anthranilate to the evaporator.

10. The method of claim 1, wherein the avian pests are selected from the group consisting of: starlings, gulls, blackbirds, grackles, rock doves, pigeons, cliff swallows, house sparrows, house finches, American crows, geese, mute swans, and coots.

11. A method of assisting in deterring avian pests, comprising:
marketing an evaporator; and
marketing a cartridge that cooperates with the evaporator to dispense a gas, wherein the cartridge includes an amount of methyl anthranilate; and
providing instructions for using the evaporator for deterring the avian pests.
